(19) United States
(12) Patent Application Publication
(10) Pub. No.: US 2017/0339117 A1
(43) Pub. Date: Nov. 23, 2017

(54) INFORMATION SYSTEM, PERSONAL COMPUTER, DRIVE DEVICE, CONTROL METHOD, AND PROGRAM

(71) Applicant: NEC Platforms, Ltd., Kanagawa (JP)

(72) Inventor: Shin SATOU, Kanagawa (JP)

(21) Appl. No.: 15/223,291

(22) Filed: Jul. 29, 2016

Related U.S. Application Data
(60) Provisional application No. 62/338,146, filed on May 18, 2016.

(51) Int. Cl. H04L 29/06

(52) U.S. Cl. CPC H04L 63/061

(57) ABSTRACT

Disclosed are an information system etc. including; a personal computer including: a decryption key acquisition unit which acquires a decryption key used to release encryption of data in a storage medium encrypted by a library device; a decryption key sending unit which controls to send the decryption key acquired by the decryption key acquisition unit to the drive device; and an encryption-release-information-signal reception unit which controls to receive an encryption-release-information-signal from the drive device, the encryption-release-information-signal indicating that the drive device has released the encryption, and a drive device including: a decryption key reception unit which controls to receive the decryption key from the personal computer; an encryption release unit which releases the encryption based on the decryption key; and an encryption-release-information-signal sending unit which controls to send the encryption-release-information-signal to the personal computer when the encryption release unit releases the encryption.

This application is based upon and claims the benefit of priority from Provisional U.S. Patent Application No. 62/338,146, filed on May 18, 2016, the disclosure of which is incorporated herein in its entirety by reference.

### TECHNICAL FIELD

The present invention relates to an information system, a personal computer, a drive device, a control method, and a program.

### BACKGROUND ART

A library device is available which reads and writes data from and to a storage medium such as a magnetic tape. In general, the library device encrypts data stored in the storage medium.

Japanese Patent Application Laid-Open Publication No. 2010-4516 discloses a related technique regarding encryption keys.

FIG. 11 is a block diagram illustrating an example of a storage medium 6 and related systems which access the storage medium 6.

The storage medium 6 is deposited in a repository 4 storing data encrypted by a library device 30. A library system 3 and an information system 5 serve as related systems which access the storage medium 6.

The storage medium 6 is generally used for data recording. Therefore, the storage medium 6 that stores data recorded and encrypted by the library device 30 is often taken out of the library device 30 and deposited in the repository 4, such as a warehouse.

### SUMMARY

Under the above-mentioned circumstances, the data stored in the storage medium 6 is generally read using a library system 3 including a library device 30, and a library device terminal computer 40 which commands the library device 30 to release the encryption. However, when a drive 303 of the library device 30 is unavailable for some reason, for example, because the drive 303 is being used to record data stored in other storage media, the storage medium 6 taken out of the repository 4 cannot be directly inserted into the library device 30 and, in turn, cannot be accessed rapidly. Assume herein that an information system 5 including a drive device 20 which reads the storage medium 6, and a related personal computer 7 connected to the drive device 20 is located. Even in this case, since the data in the storage medium 6 has been encrypted by the library device 30, the storage medium 6 cannot be accessed by drive devices including no decryption keys.

A demand has thus arisen for a technique which allows easy access to the storage medium storing data encrypted by the library device.

In view of the above-described situation, it is an object of this invention to provide an information system, a personal computer, a drive device, a control method, and a program which can solve the above-described problem.

To achieve the above-described object, one aspect of the present invention is an information system including:

a personal computer which acquires a decryption key for releasing encryption of data in a storage medium encrypted by a library device; and a drive device which releases the encryption of the data in the storage medium inserted in the drive device using the decryption key,

the personal computer includes:

a decryption key acquisition unit which acquires a decryption key used to release encryption of data in a storage medium encrypted by a library device;

a decryption key sending unit which controls to send the decryption key acquired by the decryption key acquisition unit to the drive device; and

an encryption-release-information-signal reception unit which controls to receive an encryption-release-information-signal from the drive device, the encryption-release-information-signal indicating that the drive device has released the encryption, and

the drive device includes:

a decryption key reception unit which controls to receive the decryption key from the personal computer;

an encryption release unit which releases the encryption based on the decryption key; and

an encryption-release-information-signal sending unit which controls to send the encryption-release-information-signal to the personal computer when the encryption release unit releases the encryption.

Another aspect of the present invention is a personal computer including:

a decryption key acquisition unit which acquires a decryption key used to release encryption of data in a storage medium encrypted by a library device;

a decryption key sending unit which controls to send the decryption key acquired by the decryption key acquisition unit to a drive device; and

an encryption-release-information-signal reception unit which controls to receive an encryption-release-information-signal from the drive device, the encryption-release-information-signal indicating that the drive device has released the encryption.

Another aspect of the present invention is a drive device including:

a decryption key reception unit which controls to receive the decryption key from the personal computer, the decryption key being used to release encryption of data in a storage medium encrypted by a library device,

an encryption release unit which releases the encryption based on the decryption key; and

an encryption-release-information-signal sending unit which controls to send the encryption-release-information-signal indicating the encryption is released to the personal computer when the encryption release unit releases the encryption.

Another aspect of the present invention is a control method in an information system including a personal computer which acquires a decryption key for releasing encryption of data in a storage medium encrypted by a library device; and a drive device which releases the encryption of the data in the storage medium inserted in the drive device using the decryption key, the control method including;

acquiring a decryption key used to release encryption of data in a storage medium encrypted by a library device;

controlling to send the acquired decryption key;

controlling to receive the decryption key from the personal computer;

controlling to send the encryption-release-information-signal to the personal computer when the encryption is released based on the decryption key.

Another aspect of the present invention is a control method including:

acquiring a decryption key used to release encryption of data in a storage medium encrypted by a library device;

controlling to send the acquired decryption key to a drive device; and

controlling to receive an encryption-release-information-signal from the drive device, the encryption-release-information-signal indicating that the encryption has been released.

Another aspect of the present invention is a control method including:

controlling to receive the decryption key from the personal computer, the decryption key being used to release encryption of data in a storage medium encrypted by a library device;

releasing the encryption based on the decryption key; and

controlling to send the encryption-release-information-signal indicating the encryption is released to the personal computer when the encryption is released.

Another aspect of the present invention is a non-transitory computer-readable storage medium storing a program causing a personal computer to perform as:

a decryption key acquisition unit which acquires a decryption key used to release encryption of data in a storage medium encrypted by a library device;

a decryption key sending unit which controls to send the decryption key acquired by the decryption key acquisition unit to the drive device; and

an encryption-release-information-signal reception unit which controls to receive an encryption-release-information-signal from the drive device, the encryption-release-information-signal indicating that the drive device has released the encryption.

Another aspect of the present invention is a non-transitory computer-readable storage medium storing a program causing a computer of drive device to perform as:

a decryption key reception unit which controls to receive the decryption key from the personal computer, the decryption key being used to release encryption of data in a storage medium encrypted by a library device,

an encryption release unit which releases the encryption based on the decryption key; and

an encryption-release-information-signal sending unit which controls to send the encryption-release-information-signal indicating the encryption is released to the personal computer when the encryption release unit releases the encryption.

The present invention allows easy access to the storage medium storing data encrypted by the library device.

### BRIEF DESCRIPTION OF THE DRAWINGS

Exemplary features and advantages of the present invention will become apparent from the following detailed description when taken with the accompanying drawings in which:

FIG. 1 is a block diagram illustrating an exemplary minimum configuration of a personal computer 10 according to the present invention;

FIG. 2 is a block diagram illustrating an exemplary entire system including an information system 1 and a library system 2 according to a first exemplary embodiment of the present invention;

FIG. 3 is a block diagram illustrating an exemplary configuration of the information system 1 including the personal computer 10 according to the first exemplary embodiment of the present invention;

FIG. 4 is a block diagram illustrating an exemplary configuration of the library system 2 that uses the library device 30 to export a decryption key to the storage device 50 according to the first exemplary embodiment of the present invention;

FIG. 5 is a table illustrating an example of a data table TBL1 stored in the library device 30 according to the first exemplary embodiment of the present invention;

FIG. 6 is a sequence chart illustrating an exemplary processing sequence of the library system 2 according to the first exemplary embodiment of the present invention;

FIG. 7 is a sequence chart illustrating an exemplary processing sequence of the information system 1 according to the first exemplary embodiment of the present invention;

FIG. 8 is a block diagram illustrating an exemplary configuration of an information system 1 including a personal computer 10 according to a second exemplary embodiment of the present invention;

FIG. 9 is a block diagram illustrating an exemplary configuration of a storage medium 60 according to the second exemplary embodiment of the present invention;

FIG. 10 is a sequence chart illustrating an exemplary processing sequence of the information system 1 according to the second exemplary embodiment of the present invention; and

FIG. 11 is a block diagram illustrating an example of a storage medium 6 storing data encrypted by a library device 30, and related systems which access the storage medium 6.

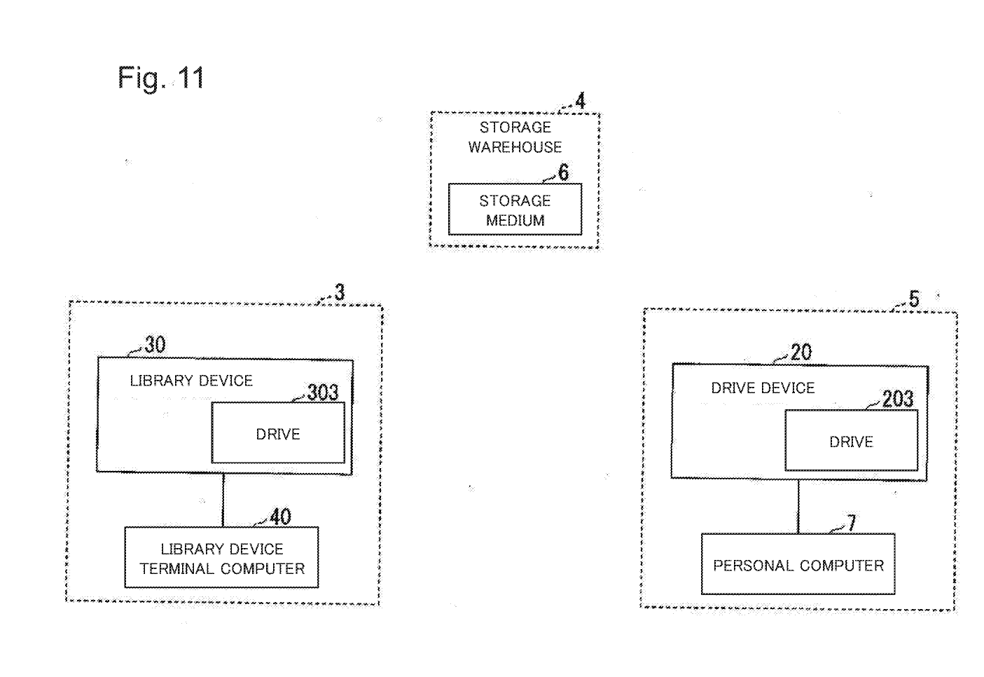

### EXEMPLARY EMBODIMENT

Exemplary embodiments will be described in detail below with reference to the accompanying drawings.

A personal computer 10 having a minimum configuration according to the present invention will be described first.

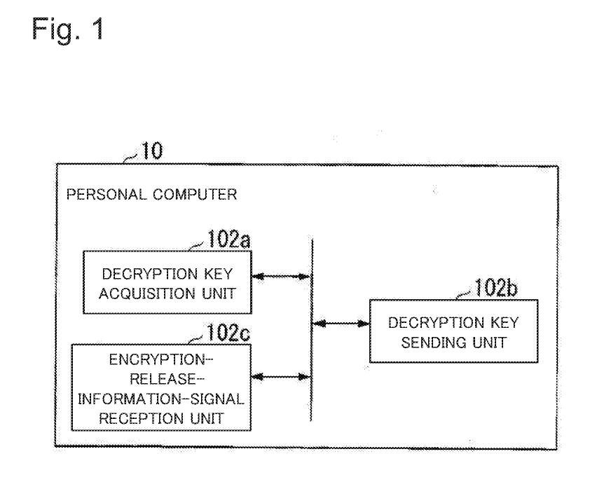

FIG. 1 is a block diagram illustrating an exemplary minimum configuration of the personal computer 10 according to one aspect of the present invention.

The personal computer 10 according to one aspect of the present invention includes at least a decryption key acquisition unit 102a, a decryption key sending unit 102b, and an encryption-release-information-signal reception unit 102c, as illustrated in FIG. 1.

The decryption key acquisition unit 102a of the personal computer 10 acquires a decryption key used to release the encryption of data in a storage medium 6 (for example, a magnetic tape) encrypted by a library device.

The decryption key sending unit 102b controls to send the decryption key acquired by the decryption key acquisition unit 102a to a drive device.

The encryption-release-information-signal reception unit 102c controls to receive from the drive device, an encryption-release-information-signal indicating that the drive device has released the encryption.

### First Exemplary Embodiment

The configuration of an entire system 8 including an information system 1 and a library system 2 according to a first exemplary embodiment of the present invention will be described next.

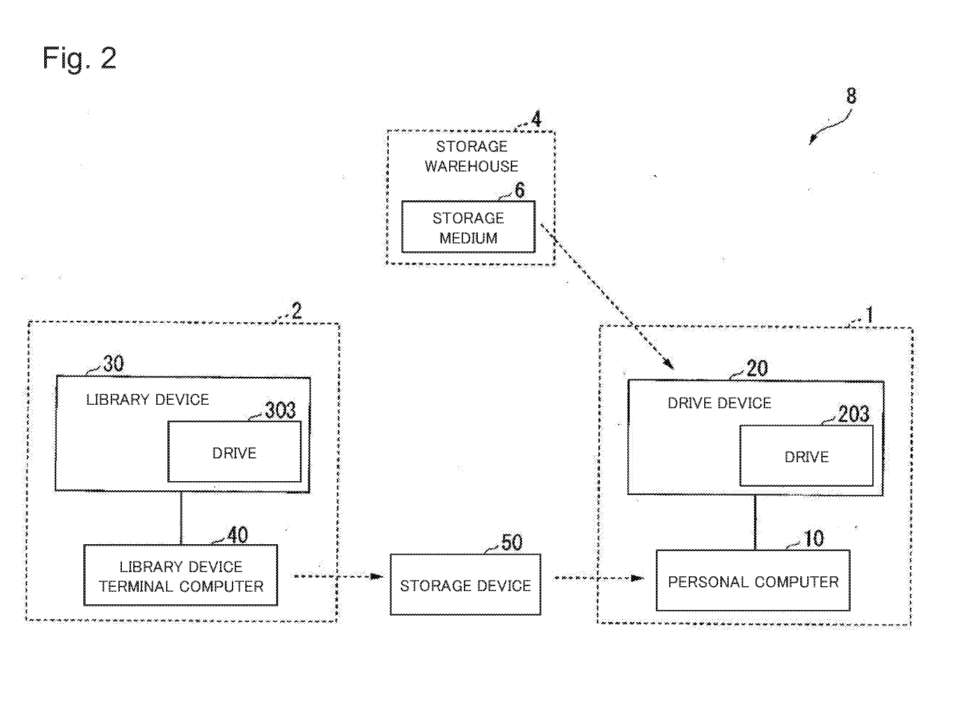

FIG. 2 is a block diagram illustrating an exemplary configuration of the entire system 8 according to the first exemplary embodiment of the present invention.

The entire system 8 includes an information system 1 and a library system 2, as illustrated in FIG. 2.

When a storage medium 6 cannot be accessed by the library system 2, the user operates a library device terminal computer 40 to cause a library device 30 to export a decryption key stored in the library device 30. The user records on a portable storage device 50, the decryption key exported by the library device 30. The user carries the storage device 50 and moves from the installation location of the library system 2 to that of the information system 1. The user connects the storage device 50 to a personal computer 10 in the information system 1. The user operates and causes the personal computer 10 to be imported the decryption key stored in the storage device 50, using a function implemented by an application program. The user releases the encryption of the data in the storage medium 6 inserted in a drive device 20, using the decryption key imported in the personal computer 10.

The information system 1 and the library system 2 will be individually described in more detail below.

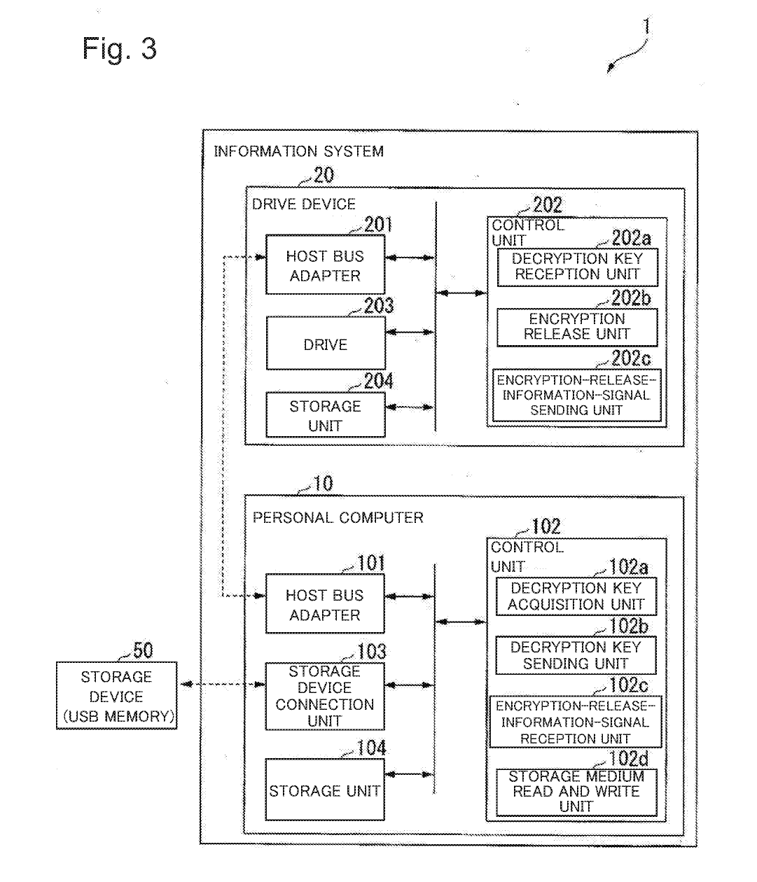

FIG. 3 is a block diagram illustrating an exemplary configuration of the information system 1 including the personal computer 10 according to the first exemplary embodiment of the present invention.

The information system 1 according to the first exemplary embodiment includes a personal computer 10 and a drive device 20, as illustrated in FIG. 3. The storage device 50 is a portable storage device located outside the personal computer 10 and is implemented in, for example, a USB memory. The storage device 50 stores the decryption key which is used to release the encryption of the data in the storage medium 6 encrypted by the library device 30.

The personal computer 10 in the information system 1 according to the first exemplary embodiment includes a host bus adapter 101, a control unit 102, a storage device connection unit 103, and a storage unit 104.

The host bus adapter 101 of the personal computer 10 serves as an interface for connecting the drive device 20 to the personal computer 10.

The control unit 102 includes each functional unit (a decryption key acquisition unit 102a, a decryption key sending unit 102b, and an encryption-release-information-signal reception unit 102c) illustrated in FIG. 1, and a storage medium read and write unit 102d.

The control unit 102 performs various types of control in the personal computer 10. The control unit 102, for example, acquires the decryption key from the storage device 50. More specifically, when a USB memory is used as the storage device 50, the decryption key acquisition unit 102a imports the decryption key from the USB memory to the personal computer 10 via the storage device connection unit 103, using a function implemented by an application program. In this manner, the control unit 102 acquires the decryption key from the storage device 50. Further, the control unit 102, for example, controls communication of the personal computer 10 with the drive device 20 via the host bus adapter 101. More specifically, the decryption key sending unit 102b controls to send the decryption key acquired by the decryption key acquisition unit 102a to the drive device 20. Even more specifically, the encryption-release-information-signal reception unit 102c controls to receive from the drive device 20, an encryption-release-information-signal indicating that the drive device 20 has released the encryption. Further, the storage medium read and write unit 102d, for example, controls to read and write data by accessing the storage medium 6, for which the encryption has been released by the drive device 20.

The storage device connection unit 103 serves as an interface for connecting the storage device 50 to the personal computer 10.

The storage unit 104 stores information required for various processes by the personal computer 10. For example, the storage unit 104 stores an application program. The application program includes a program which implements a function for causing the control unit 102 to acquire the decryption key, a host bus adapter 201, a control unit 202, a drive 203, and a storage unit 204.

The host bus adapter 201 in the drive device 20 serves as an interface for connecting the personal computer 10 to the drive device 20.

The control unit 202 includes a decryption key reception unit 202a, an encryption release unit 202b, and an encryption-release-information-signal sending unit 202c.

The control unit 202 performs various types of control in the drive device 20. The control unit 202, for example, releases the encryption of the data in the storage medium 6. More specifically, the encryption release unit 202b releases the encryption on the basis of the decryption key. Further, the control unit 202, for example, controls communication of the drive device 20 with the personal computer 10 via the host bus adapter 201. More specifically, the decryption key reception unit 202a controls to receive the decryption key from the personal computer 10. Even more specifically, the encryption-release-information-signal sending unit 202c controls to send an encryption-release-information-signal to the personal computer 10 when the encryption release unit 202b releases the encryption.

The drive 203 reads and writes data stored in the storage medium 6.

The storage unit 204 stores information required for various processes by the drive device 20.

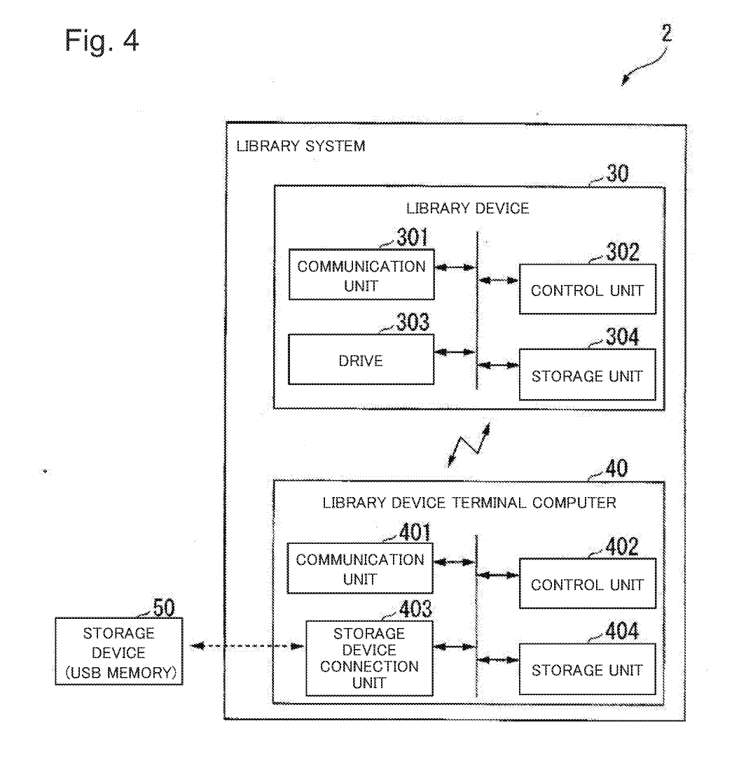

FIG. 4 is a block diagram illustrating an exemplary configuration of the library system 2 in which the library device 30 according to the first exemplary embodiment of the present invention exports the decryption key to the storage device 50.

The library system 2 according to the first exemplary embodiment includes a library device 30 and a library device terminal computer 40, as illustrated in FIG. 4.

The library device 30 of the library system 2 according to the first exemplary embodiment includes a communication unit 301, a control unit 302, a drive 303, and a storage unit 304.

The communication unit 301 in the library device 30 communicates with the library device terminal computer 40.

The control unit 302 performs various types of control in the library device 30. The control unit 302, for example, controls communication of the communication unit 301 with the library device terminal computer 40. Further, the control unit 302, for example, controls the drive 303. Moreover, the control unit 302, for example, encrypts the data stored in the storage medium 6 inserted in the drive 303. The control unit 302 executes an encryption program using, for example, the AES (Advanced Encryption Standard) algorithm to encrypt the data stored in the storage medium 6.

The drive 303 reads and writes data stored in the storage medium 6.

The storage unit 304 stores information required for various processes by the library device 30. For example, the storage unit 304 stores the decryption key used to release the encryption of the data in the storage medium 6 encrypted by the control unit 302 in the library device 30.

The library device terminal computer 40 includes a communication unit 401, a control unit 402, a storage device connection unit 403, and a storage unit 404.

The communication unit 401 in the library device terminal computer 40 communicates with the library device 30.

The control unit 402 performs various types of control in the library device terminal computer 40. The control unit 402, for example, controls communication of the communication unit 401 with the library device 30. Further, the control unit 402, for example, acquires the decryption key from the library device 30. More specifically, the control unit 402 sends a decryption key request signal indicating a decryption key request to the library device 30 via the communication unit 401, using the browser function. The control unit 302 in the library device 30 then exports the decryption key stored in the storage unit 304 to the library device terminal computer 40 on the basis of the decryption key request signal received via the communication unit 301. In this manner, the control unit 402 acquires the decryption key from the library device 30.

The storage device connection unit 403 serves as an interface for connecting the storage device 50 to the library device terminal computer 40. When the storage device 50 is implemented in, for example, a USB memory, the storage device connection unit 403 serves as a USB port of the library device terminal computer 40.

The storage unit 404 stores information required for various processes by the library device terminal computer 40. For example, the storage unit 404 stores a program which implements the browser function used by the control unit 402.

A data table TBL1 stored in the library device 30 according to the first exemplary embodiment of the present invention will be described below.

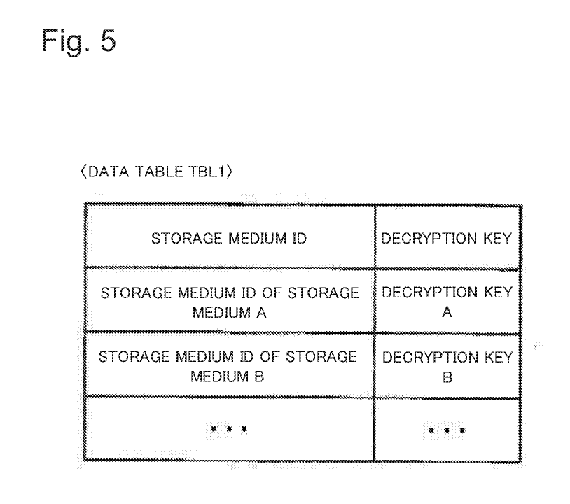

FIG. 5 is a table illustrating an example of the data table TBL1 stored in the library device 30 according to the first exemplary embodiment of the present invention.

The storage unit 304 in the library device 30 associates storage medium IDs (for example, serial numbers assigned to respective storage media 6) with decryption keys for releasing the encryption of the data in the respective storage media 6 and stores them as the data table TBL1, as illustrated in FIG. 5. In, for example, the data table TBL1 illustrated in FIG. 5, the storage unit 304 associates the storage medium ID of storage medium A that is one of the storage media 6 with decryption key A and stores them. The storage unit 304 further associates the storage medium ID of storage medium B that is one of the storage media 6 with decryption key B and stores them.

A storage medium ID is marked on the surface of the storage medium body so as to be visually perceptible to the user.

The processing of the entire system 8 including the information system 1 and the library system 2 according to the first exemplary embodiment will be described below. The following processing is performed on the basis of a function implemented by an application program stored in the storage unit of each of the information system 1 and the library system 2.

The processing of the library system 2 that exports decryption key A for releasing the encryption of the data in storage medium A encrypted by the library device 30 in the library system 2 to the storage device 50 according to the first exemplary embodiment will be described first.

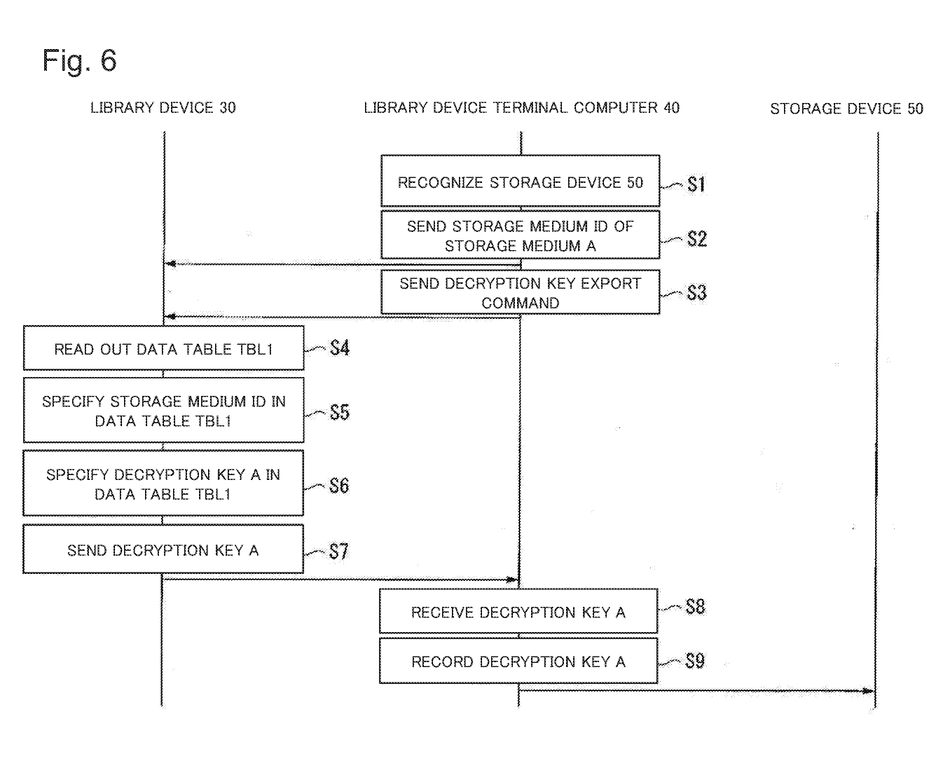

FIG. 6 is a sequence chart illustrating an exemplary processing sequence of the library system 2 according to the first exemplary embodiment of the present invention.

The user acquires the storage medium ID of storage medium A to be inserted in the drive device 20 in the information system 1 and to be accessed. For example, the user visually checks, in advance, the storage medium ID marked on storage medium A. The user carries the storage device 50 and moves to the location where the library device terminal computer 40 communicable with the library device 30 is installed. The user connects the storage device 50 to the storage device connection unit 403 of the library device terminal computer 40.

The storage device connection unit 403 then recognizes the storage device 50 (step S1). At this time, the library device terminal computer 40 is ready to write data into the storage device 50.

The user operates the library device 30 to export a decryption key for releasing the encryption of the data in storage medium A to the storage device 50, using the browser function of the library device terminal computer 40. More specifically, the user, for example, operates the library device terminal computer 40 to access the library device 30. The user operates to input the storage medium ID of storage medium A acquired in advance to the library device terminal computer 40. The user further operates the library device terminal computer 40 to send to the library device 30, the input storage medium ID of storage medium A and a decryption key export command for exporting a decryption key.

In response to these operations by the user, the control unit 402 of the library device terminal computer 40 accesses the library device 30 using the browser function of a program stored in the storage unit 404. The control unit 402 sends the storage medium ID of storage medium A to the library device 30 via the communication unit 401 (step S2). The control unit 402 sends a decryption key export command to the library device 30 (step S3).

The communication unit 301 of the library device 30 receives the storage medium ID of storage medium A and the decryption key export command from the library device terminal computer 40. The control unit 302 then reads out the data table TBL1 from the storage unit 304 (step S4).

The control unit 302 sequentially compares the received storage medium ID of storage medium A with storage medium IDs in the readout data table TBL1 to specify a storage medium ID identical to that of storage medium A in the storage medium IDs in the data table TBL1 (step S5).

The control unit 302 specifies decryption key A associated with the storage medium ID of storage medium A specified in the data table TBL1 (step S6).

The control unit 302 sends specified decryption key A to the library device terminal computer 40 via the communication unit 301 (step S7).

The communication unit 401 in the library device terminal computer 40 receives decryption key A from the library device 30 (step S8). The control unit 402 then records received decryption key A in the storage device 50 via the storage device connection unit 403 (step S9).

With this operation, the library device 30 can export decryption key A for releasing the encryption of the data in storage medium A to the storage device 50.

Processing for releasing the encryption of the data in storage medium A encrypted by the information system 1 of the personal computer 10 according to the first exemplary embodiment will be described below.

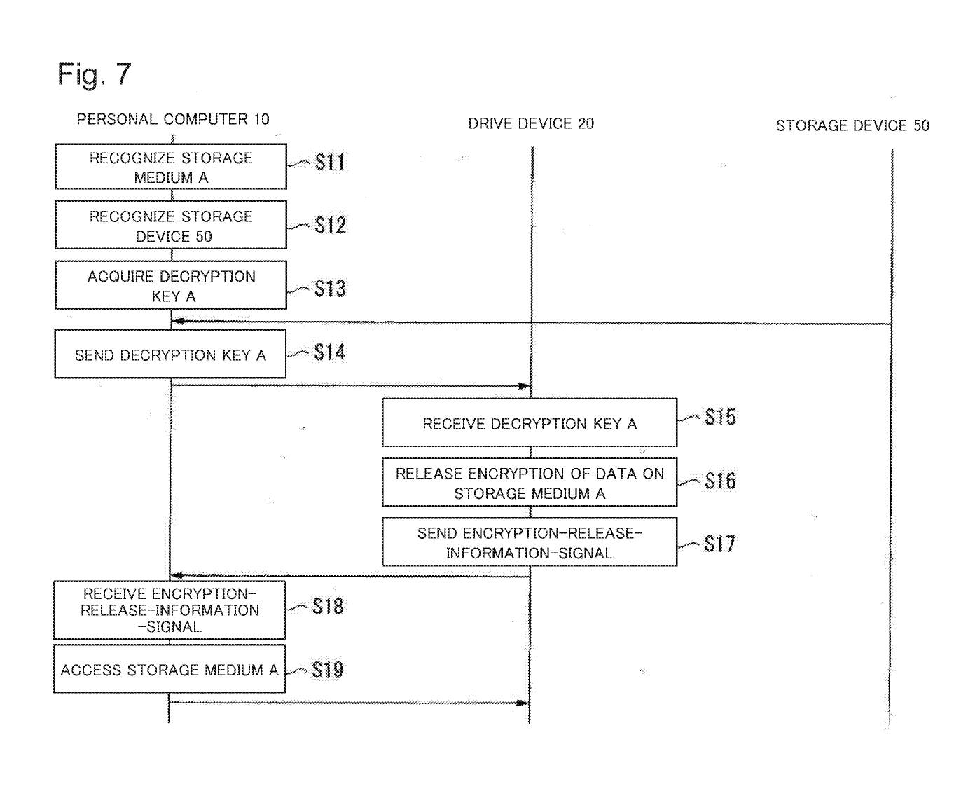

FIG. 7 is a sequence chart illustrating an exemplary processing sequence of the information system 1 according to the first exemplary embodiment of the present invention.

After the above-mentioned processes in steps S1 through S7, the user carries the storage device 50 and storage medium A and moves to the location where the personal computer 10 and the drive device 20 are installed.

The user inserts storage medium A to the drive 203. The drive 203 then recognizes storage medium A (step S11).

The user further connects the storage device 50 to the storage device connection unit 103 of the personal computer 10. The storage device connection unit 103 then recognizes the storage device 50 (step S12). At this time, the library device terminal computer 40 is ready to read data from the storage device 50.

The user operates the personal computer 10 to import decryption key A for releasing the encryption of the data in storage medium A.

In response to the operation by the user, the decryption key acquisition unit 102a in the control unit 102 of the personal computer 10 accesses the storage device 50. The decryption key acquisition unit 102a acquires decryption key A from the storage device 50 via the storage device connection unit 103 (step S13).

The decryption key sending unit 102b then sends decryption key A acquired by the decryption key acquisition unit 102a to the drive device 20 via the host bus adapter 101 (step S14).

The decryption key reception unit 202a in the control unit 202 of the drive device 20 receives decryption key A from the personal computer 10 via the host bus adapter 201 (step S15).

The encryption release unit 202b then releases the encryption of the data in storage medium A inserted in the drive 203, using decryption key A received from the personal computer 10 by the decryption key reception unit 202a (step S16).

The encryption-release-information-signal sending unit 202c sends to the personal computer 10 via the host bus adapter 201, an encryption-release-information-signal indicating that the encryption release unit 202b has released the encryption of the data in storage medium A (step S17).

The encryption-release-information-signal reception unit 102c of the control unit 102 of the personal computer 10 receives the encryption-release-information-signal from the drive device 20 via the host bus adapter 101 (step S18).

The storage medium read and write unit 102d then accesses storage medium A inserted in the drive 203 of the drive device 20 (step S19). The storage medium read and write unit 102d reads and writes data from and to storage medium A.

The processing sequence of the information system 1 according to the first exemplary embodiment of the present invention has been described above. In the above-described processing of the information system 1 according to the first exemplary embodiment, the decryption key acquisition unit 102a acquires decryption key A for releasing the encryption of the data in storage medium A encrypted by the library device 30. The decryption key sending unit 102b sends decryption key A acquired by the decryption key acquisition unit 102a to the drive device 20. After the drive device 20 releases the encryption of the data in storage medium A using decryption key A, the encryption-release-information-signal reception unit 102c receives an encryption-release-information-signal indicating that the drive device 20 has released the encryption from the drive device 20.

With this operation, the personal computer 10 in the information system 1 can easily acquire decryption key A and easily access a storage medium storing data encrypted by the library device 30.

The information system 1 including the personal computer 10 and the drive device 20 may be a portable system, which releases the encryption of the data in storage medium A at an arbitrary location. The information system 1 may even release the encryption of the data in each storage medium 60, using a master key for releasing the encryption of all data in this storage medium 60.

### Second Exemplary Embodiment

An information system 1 according to a second exemplary embodiment of the present invention will be described next.

A personal computer 10 according to the second exemplary embodiment acquires a decryption key not from the storage device 50 but from a library device 30, unlike the personal computer 10 according to the first exemplary embodiment.

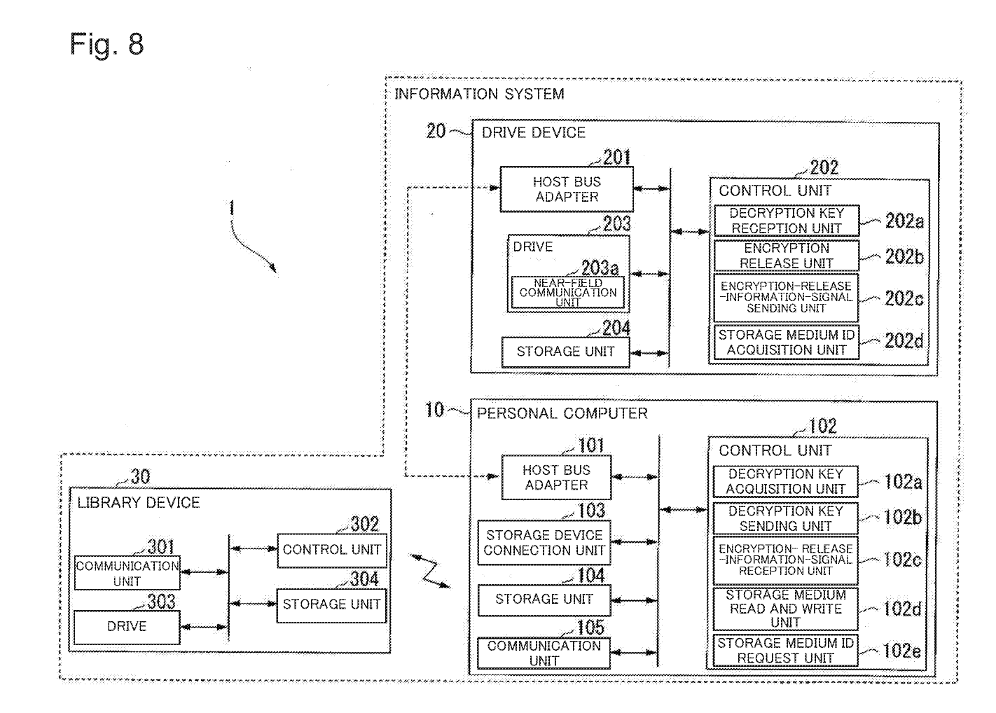

FIG. 8 is a block diagram illustrating an exemplary configuration of the information system 1 including the personal computer 10 according to the second exemplary embodiment of the present invention.

The information system 1 according to the second exemplary embodiment includes a personal computer 10, a drive device 20, and a library device 30, as illustrated in FIG. 8.

The personal computer 10 in the information system 1 according to the second exemplary embodiment includes a host bus adapter 101, a control unit 102, a storage device connection unit 103, a storage unit 104, and a communication unit 105.

The control unit 102 includes a decryption key acquisition unit 102a, a decryption key sending unit 102b, an encryption-release-information-signal reception unit 102c, a storage medium read and write unit 102d, and a storage medium ID request unit 102e.

The control unit 102 performs various types of control in the personal computer 10. For example, the storage medium ID request unit 102e in the control unit 102 acquires the storage medium ID of a storage medium 60 inserted in a drive 203 of the drive device 20, via the host bus adapter 101 using a function implemented by an application program. The decryption key acquisition unit 102a acquires a decryption key for the storage medium 60 corresponding to the storage medium ID acquired by the storage medium ID request unit 102e, via the communication unit 105 using a function implemented by an application program.

The storage unit 104 stores information required for various processes by the personal computer 10. For example, the storage unit 104 stores an application program. The application program includes a program which implements the function of acquiring a decryption key by the control unit 102.

The communication unit 105 communicates with the library device 30.

The drive device 20 includes a host bus adapter 201, a control unit 202, a drive 203, and a storage unit 204.

The control unit 202 includes a decryption key reception unit 202a, an encryption release unit 202b, an encryption-release-information-signal sending unit 202c, and a storage medium ID acquisition unit 202d.

The control unit 202 performs various types of control in the drive device 20. For example, the storage medium ID acquisition unit 202d acquires the storage medium ID of the storage medium 60 from the storage medium 60 via a near field communication unit 203a of the drive 203.

The drive 203 reads and writes data stored in the storage medium 60. The drive 203 includes a near field communication unit 203a. The near field communication unit 203a of the drive 203 performs near field communication with the storage medium 60 when the storage medium 60 is inserted in the drive 203. At this time, the control unit 202 acquires a storage medium ID representing the identifier of the storage medium 60 via the near field communication unit 203a.

The storage unit 204 stores information required for various processes by the drive device 20.

The library device 30 includes a communication unit 301, a control unit 302, a drive 303, and a storage unit 304.

The communication unit 301 of the library device 30 communicates with the personal computer 10.

The control unit 302 performs various types of control in the library device 30. The control unit 302, for example, controls communication of the communication unit 301 with the personal computer 10.

The storage unit 304 stores information required for various processes by the library device 30.

The configuration of the storage medium 60 according to the second exemplary embodiment of the present invention will be described below.

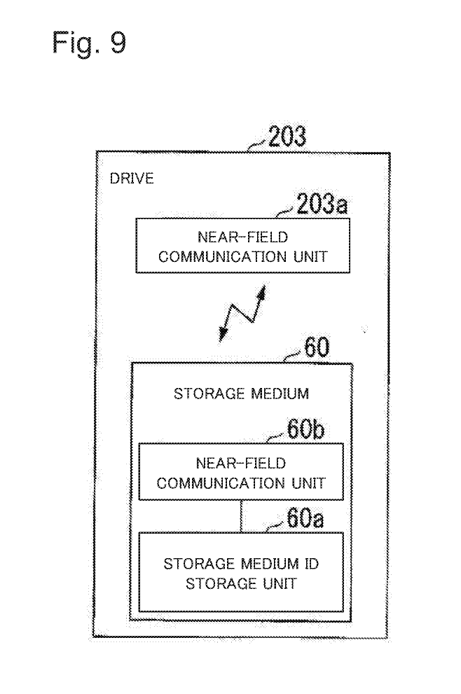

FIG. 9 is a block diagram illustrating an exemplary configuration of the storage medium 60 inserted in the drive 203 according to the second exemplary embodiment of the present invention.

The storage medium 60 according to the second exemplary embodiment includes a storage medium ID storage unit 60a and a near-field communication unit 60b, as illustrated in FIG. 9.

The storage medium ID storage unit 60a of the storage medium 60 stores storage medium IDs. For example, the storage medium ID storage unit 60a uses a memory circuit implemented on an IC (Integrated Circuit) chip.

The near-field communication unit 60b performs near-field communication with the near-field communication unit 203a of the drive 203 when the storage medium 60 is inserted in the drive 203 of the drive device 20. For example, the near-field communication unit 60b sends the storage medium ID stored in the storage medium ID storage unit 60a to the drive 203, using non-contact near-field communication.

With this operation, the drive 203 or 303 can acquire the storage medium ID of the storage medium 60.

Processing for releasing the encryption of the data in the storage medium 60 encrypted by the information system 1 of the personal computer 10 according to the second exemplary embodiment of the present invention will be described below.

The following processing is performed on the basis of an application program stored in each storage unit.

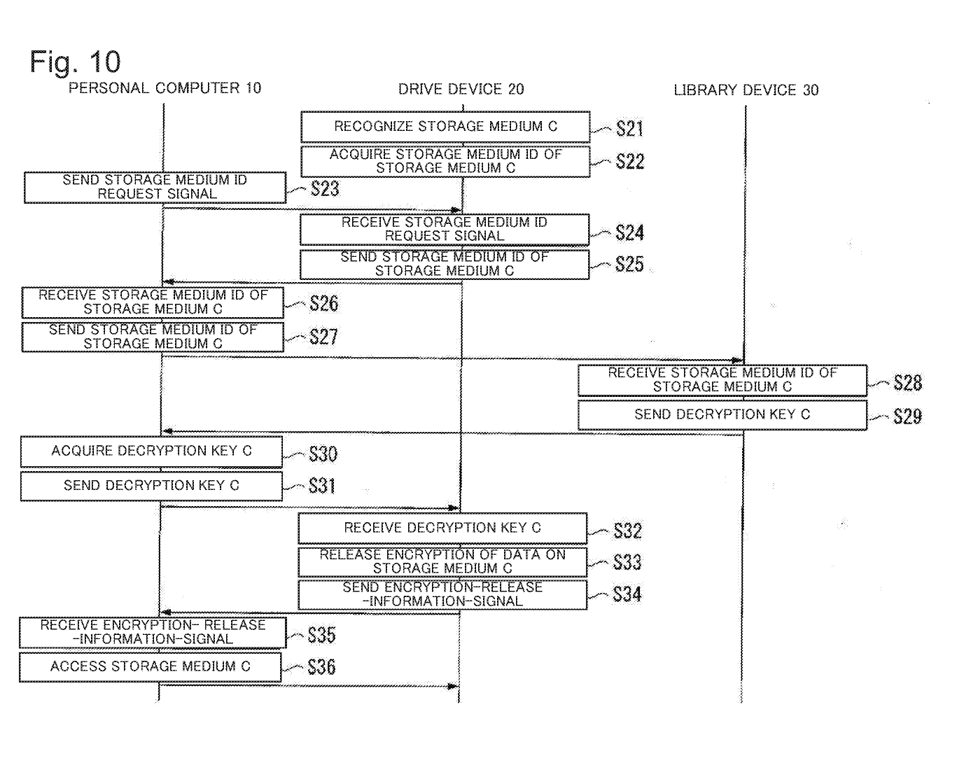

FIG. 10 is a sequence chart illustrating an exemplary processing sequence of the information system 1 according to the second exemplary embodiment of the present invention.

The user carries storage medium C that is one of storage media 60 and moves to the location where the personal computer 10 and the drive device 20 are located. The user connects the host bus adapter 101 of the personal computer 10 and the host bus adapter 201 of the drive device 20 to each other. The user inserts storage medium C into the drive 203.

The drive 203 then recognizes storage medium C (step S21). At this time, the storage medium ID acquisition unit 202d of the control unit 202 acquires the storage medium ID of storage medium C sent to the drive 203 by the near-field communication unit 60b and stored in the storage medium ID storage unit 60a (step S22).

The user operates the personal computer 10 to request the drive device 20 to send the storage medium ID acquired by the storage medium ID acquisition unit 202d.

In response to the operation by the user, the storage medium ID request unit 102e of the control unit 102 of the personal computer 10 sends a storage medium ID request signal indicating a storage medium ID request to the drive device 20 via the host bus adapter 101 (step S23).

The storage medium ID acquisition unit 202d in the control unit 202 of the drive device 20 receives the storage medium ID request signal from the personal computer 10 via the host bus adapter 201 (step S24). The storage medium ID acquisition unit 202d sends the storage medium ID of storage medium C acquired by the process in step S22 to the personal computer 10 via the host bus adapter 201, in response to the received storage medium ID request signal (step S25).

The storage medium ID request unit 102e in the personal computer 10 receives the storage medium ID of storage medium C from the drive device 20 via the host bus adapter 101 (step S26).

The decryption key acquisition unit 102a then sends the storage medium ID of storage medium C received by the storage medium ID request unit 102e to the library device 30 via the communication unit 105 (step S27).

The control unit 302 in the library device 30 receives the storage medium ID of storage medium C from the personal computer 10 via the communication unit 301 (step S28). In response to the received storage medium ID of storage medium C, the control unit 302 sends decryption key C corresponding to the storage medium ID of storage medium C stored in the storage unit 304 to the personal computer 10 via the communication unit 301 (step S29).

The decryption key acquisition unit 102a in the control unit 102 of the personal computer 10 acquires decryption key C from the library device 30 via the communication unit 105 (step S30).

The decryption key sending unit 102b then sends decryption key C acquired by the decryption key acquisition unit 102a to the drive device 20 via the host bus adapter 101 (step S31).

The decryption key reception unit 202a in the control unit 202 of the drive device 20 receives decryption key C from the personal computer 10 via the host bus adapter 201 (step S32).

The encryption release unit 202b then releases the encryption of the data in storage medium C inserted in the drive 203, using decryption key C received from the personal computer 10 by the decryption key reception unit 202a (step S33).

The encryption-release-information-signal sending unit 202c sends to the personal computer 10 via the host bus adapter 201, an encryption-release-information-signal indicating that the encryption release unit 202b has released the encryption of the data in storage medium C (step S34).

The encryption-release-information-signal reception unit 102c in the control unit 102 of the personal computer 10 receives the encryption-release-information-signal from the drive device 20 via the host bus adapter 101 (step S35).

The storage medium read and write unit 102d then accesses storage medium C inserted in the drive 203 of the drive device 20 (step S36). The storage medium read and write unit 102d reads and writes data from and to storage medium C.

The processing sequence of the information system 1 according to the second exemplary embodiment of the present invention has been described above. In the above-described processing of the information system 1 according to the second exemplary embodiment, the decryption key acquisition unit 102a acquires decryption key C for storage medium C via a network from the storage unit 304 in the library device 30 storing the decryption key.

With this operation, the personal computer 10 in the information system 1 can easily acquire decryption key C and easily access storage medium C storing data encrypted by the library device 30.

Each storage unit in the present invention may be located anywhere within the range in which appropriate information sending and reception are performed. A plurality of storage units may even be located within the range in which appropriate information sending and reception are performed to store data in a distributed manner.

In the processing sequence according to the exemplary embodiment of the present invention, the order of processes may be rearranged within the range in which appropriate processing is performed.

Exemplary embodiments of the present invention have been described above, in which each of the above-mentioned personal computer 10, drive device 20, library device 30, and library device terminal computer 40 includes an internal computer system. The processes of the above-mentioned processing are stored in a computer-readable recording medium in the form of a program, and the above-mentioned processing is performed by reading and executing the program by the computer. Examples of the computer-readable recording medium include a magnetic disk, a magnetooptical disk, a CD-ROM, a DVD-ROM, and a semiconductor memory. The computer program may be delivered to the computer via a communication line so that the computer executes the program upon the delivery.

The above-mentioned program may be used to implement some of the above-mentioned functions. The above-mentioned program may even serve as a so-called difference file (difference program) which can implement the above-mentioned functions in combination with a program already recorded in the computer system.

Although several exemplary embodiments of the present invention have been described above, these exemplary embodiments are provided merely as examples and are not intended to limit the scope of the invention. Various omissions, replacements, and changes may be made without departing from the spirit of the invention.

1. An information system comprising:
a personal computer which acquires a decryption key for releasing encryption of data in a storage medium encrypted by a library device; and a drive device which releases the encryption of the data in the storage medium inserted in the drive device using the decryption key,
the personal computer including:
a decryption key acquisition unit which acquires a decryption key used to release encryption of data in a storage medium encrypted by a library device;
a decryption key sending unit which controls to send the decryption key acquired by the decryption key acquisition unit to the drive device; and
an encryption-release-information-signal reception unit which controls to receive an encryption-release-information-signal from the drive device, the encryption-release-information-signal indicating that the drive device has released the encryption, and
the drive device including:
a decryption key reception unit which controls to receive the decryption key from the personal computer;
an encryption release unit which releases the encryption based on the decryption key; and
an encryption-release-information-signal sending unit which controls to send the encryption-release-information-signal to the personal computer when the encryption release unit releases the encryption.

2. A personal computer comprising:
a decryption key acquisition unit which acquires a decryption key used to release encryption of data in a storage medium encrypted by a library device;
a decryption key sending unit which controls to send the decryption key acquired by the decryption key acquisition unit to a drive device; and
an encryption-release-information-signal reception unit which controls to receive an encryption-release-information-signal from the drive device, the encryption-release-information-signal indicating that the drive device has released the encryption.

3. The personal computer according to claim 2, wherein when a portable storage device located outside the personal computer storing the decryption key acquired from the library device is connected to the personal computer, the decryption key acquisition unit acquires the decryption key from the storage device.

4. The personal computer according to claim 2, wherein the decryption key acquisition unit acquires the decryption key via a network from a storage unit included in the library device storing the decryption key.

5. The personal computer according to claim 2, further comprising:
a storage medium read and write unit which controls to read and write data by accessing the storage medium, for which the encryption has been released by the drive device.

6. A drive device comprising:
a decryption key reception unit which controls to receive the decryption key from the personal computer, the decryption key being used to release encryption of data in a storage medium encrypted by a library device,
an encryption release unit which releases the encryption based on the decryption key; and
an encryption-release-information-signal sending unit which controls to send the encryption-release-information-signal indicating the encryption is released to the personal computer when the encryption release unit releases the encryption.

7. A control method in an information system including a personal computer which acquires a decryption key for releasing encryption of data in a storage medium encrypted by a library device; and a drive device which releases the encryption of the data in the storage medium inserted in the drive device using the decryption key, the control method comprising;
acquiring a decryption key used to release encryption of data in a storage medium encrypted by a library device;
controlling to send the acquired decryption key;
controlling to receive the decryption key from the personal computer;
controlling to send the encryption-release-information-signal to the personal computer when the encryption is released based on the decryption key.

8. A control method comprising:
acquiring a decryption key used to release encryption of data in a storage medium encrypted by a library device;
controlling to send the acquired decryption key to a drive device; and
controlling to receive an encryption-release-information-signal from the drive device, the encryption-release-information-signal indicating that the encryption has been released.

9. A control method comprising:
controlling to receive the decryption key from the personal computer, the decryption key being used to release encryption of data in a storage medium encrypted by a library device;
releasing the encryption based on the decryption key; and
controlling to send the encryption-release-information-signal indicating the encryption is released to the personal computer when the encryption is released.

10. A non-transitory computer-readable storage medium storing a program causing a personal computer to perform as:
a decryption key acquisition unit which acquires a decryption key used to release encryption of data in a storage medium encrypted by a library device;
a decryption key sending unit which controls to send the decryption key acquired by the decryption key acquisition unit to the drive device; and
an encryption-release-information-signal reception unit which controls to receive an encryption-release-information-signal from the drive device, the encryption-release-information-signal indicating that the drive device has released the encryption.

11. A non-transitory computer-readable storage medium storing a program causing a computer of drive device to perform as:
a decryption key reception unit which controls to receive the decryption key from the personal computer, the decryption key being used to release encryption of data in a storage medium encrypted by a library device,
an encryption release unit which releases the encryption based on the decryption key; and
an encryption-release-information-signal sending unit which controls to send the encryption-release-information-signal indicating the encryption is released to the personal computer when the encryption release unit releases the encryption.

12. The personal computer according to claim 3, wherein the decryption key acquisition unit acquires the decryption key via a network from a storage unit included in the library device storing the decryption key.

13. The personal computer according to claim 3, further comprising:
a storage medium read and write unit which controls to read and write data by accessing the storage medium, for which the encryption has been released by the drive device.

14. The personal computer according to claim 4, further comprising:
a storage medium read and write unit which controls to read and write data by accessing the storage medium, for which the encryption has been released by the drive device.
